(19) United States
(12) Patent Application Publication
(10) Pub. No.: US 2011/0176939 A1
(43) Pub. Date: Jul. 21, 2011

(54) DECOUPLEABLE PULLEY FOR CONTROLLING A WATER PUMP

(75) Inventors: Massimo Pasta, Torino (IT); Adriano Rolando, Valperga Canavese (IT)

(73) Assignee: DAYCO EUROPE S.R.L., Frazione Chieti Scalo (IT)

(21) Appl. No.: 12/736,841

(22) PCT Filed: May 6, 2009
(86) PCT No.: PCT/IB2009/005491

§ 371 Date: Feb. 10, 2011

(30) Foreign Application Priority Data
May 7, 2008 (IT) TO2008A000341

(51) Int. Cl. F04B 35/00; F16H 55/36

(52) U.S. Cl. 417/374; 474/166

(57) ABSTRACT

A pulley assembly comprising a locking assembly connected to an input shaft of a water pump, a pulley mounted in a idle condition with respect to the shaft, an armature which is axially mobile in order to selectively cooperate by friction with the pulley, an electromagnet to displace the armature arranged on the axially opposite side of the pulley with respect to the armature, and an elastic element preloaded to maintain the armature in contact against the pulley when the electromagnet is not energised and having a substantially flat shape in its non-preloaded or non-deformed configuration.

### TECHNICAL FIELD

The present invention relates to a decoupleable pulley for controlling a water pump of an internal combustion engine of a vehicle, for instance a motor vehicle.

The recent regulations for the homologation of vehicles impose strict limitations to polluting emissions. One of the methods to satisfy such regulations consists in disabling the water pump after the ignition of the engine for a time interval suitable to promote the rapid heating of the combustion chamber of the engine.

### BACKGROUND ART

A known solution provides that an input shaft of the water pump is connected to a decoupleable pulley provided with an electromagnetic control device.

In particular, the pulley is mounted idle on the shaft of the pump and an electromagnet-controlled clutch rotationally couples or decouples the shaft itself to the pulley, driven in turn by a conventional accessory drive belt.

The problem may occur of upgrading engines that have already been designed or of providing a decoupleable pulley for an engine in an advanced design stage in which the radial or axial volumes in the area of the pulley of the water pump may no longer be modified.

For this reason the need is felt to provide a decoupleable pulley having radial and/or axial volumes such as to be mounted on engines originally designed for a traditional configuration of the water pump, i.e. for a configuration in which the input shaft of the water pump is rigidly connected to a pulley driven by the accessory drive belt.

A solution to this problem is shown in patent application WO-A-2006056494 that shows a pulley mounted idle on an input shaft of a water pump, an electromagnet fixed with respect to a wall of the internal combustion engine, a splined hub rigidly connected to the input shaft, an armature that may slide on the hub and a Belleville spring to maintain the armature in contact with the pulley and ensure the driving of the pump when the electromagnet is not energised.

It has been verified that the sliding coupling has a complex design that considerably increases the overall cost of the pulley assembly. Furthermore, the force applied to the armature by the Belleville spring is particularly sensitive to the wear of the friction material interposed between the armature and the pulley. In particular, even for reduced wears of the friction material, the force applied by the Belleville spring considerably decreases so as to compromise the driving of the water pump.

In a second embodiment shown in the above indicated patent, the pulley assembly comprises the above specified components with the difference that the spring has a plurality of leaves and the armature is supported by the spring by means of an intermediate element. The expression “leaf spring” in the description and in the claims, indicates an elastic element in which the material mainly works by bending according to a substantially linear elastic characteristic curve so that a single value of stiffness may be identified during designing. In this embodiment, the spring has a non-deformed configuration having a three-dimensional development. Therefore, when mounted on the pulley, the spring may take a substantially flat shape when preloaded. During the process of production, an appropriate processing is required which increases the overall cost of this component.

### DISCLOSURE OF INVENTION

It is the object of the present invention to produce a pulley assembly free of the above specified drawbacks.

The object of the present invention is achieved by means of a pulley assembly according to claim 1.

### BRIEF DESCRIPTION OF THE DRAWINGS

For a better understanding of the present invention, a preferred embodiment thereof is disclosed hereinafter by way of non-limitative example and with reference to the accompanying drawings, in which:

FIG. 1 is an axial section of a pulley assembly according to the present invention;

FIG. 2 is an exploded perspective view of FIG. 1 with some components removed for clarity;

FIG. 3 is a diagram that compares the trend of the axial forces acting on the armature of the pulley assembly of FIG. 1 as the gap between the armature and the electromagnet vary;

FIG. 4 shows a second embodiment of the present invention.

### BEST MODE FOR CARRYING OUT THE INVENTION

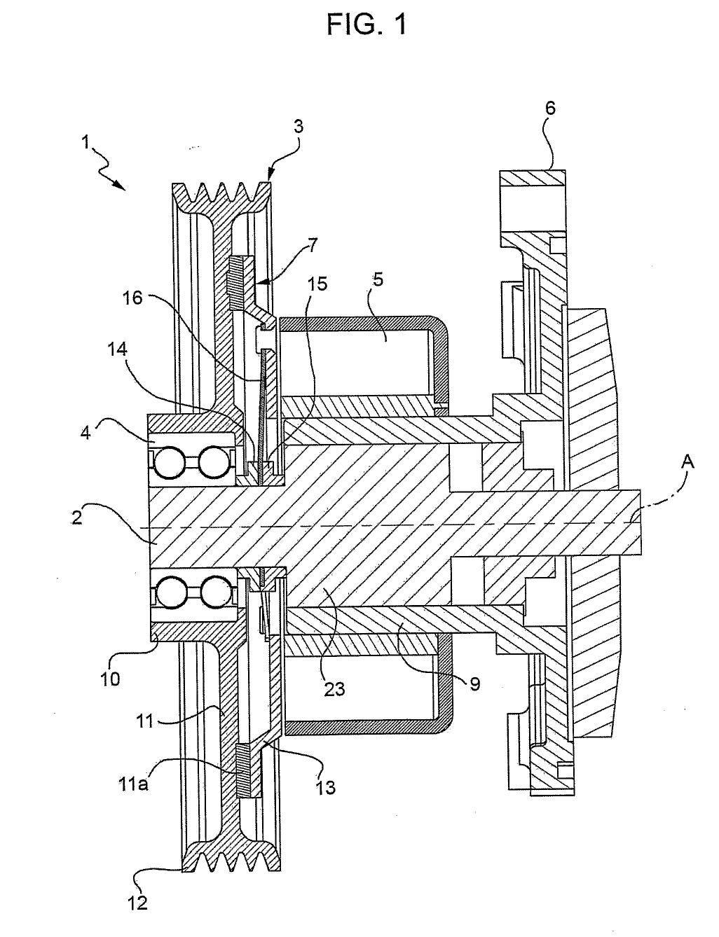

With reference to FIG. 1, numeral 1 indicates as a whole a pulley assembly having an axis A adapted to be connected to an input shaft 2 of a water pump of an internal combustion chamber. Pulley assembly 1 comprises a pulley 3 radially supported on shaft 2 by means of a ball bearing 4, an electromagnet 5 fixed with respect to a pump body 6 and a friction coupling 7 that may be driven by electromagnet 5 to selectively connect pulley 3 to shaft 2.

Pulley assembly 1 is mounted on pump body 6 through a tubular portion 9 which houses shaft 2 and supports electromagnet 5. Pump body 6 is then rigidly connected to the internal combustion engine and pulley 3 is driven by an accessory drive belt (not shown).

Pulley 3 preferably comprises in a single body a hub 10 on which bearing 4 is driven, a web 11 radially extending from hub 10 and a crown 12 borne by web 11 and adapted to cooperate with a poly-V belt.

Friction coupling 7 comprises an armature 13 facing web 11, a ring 11a made of friction material preferably rigidly connected to web 11 for cooperating with armature 13, a locking assembly comprising two rings 14, driven on shaft 2 and a leaf spring 16 mounted on locking assembly 14, 15 for radially supporting armature 13.

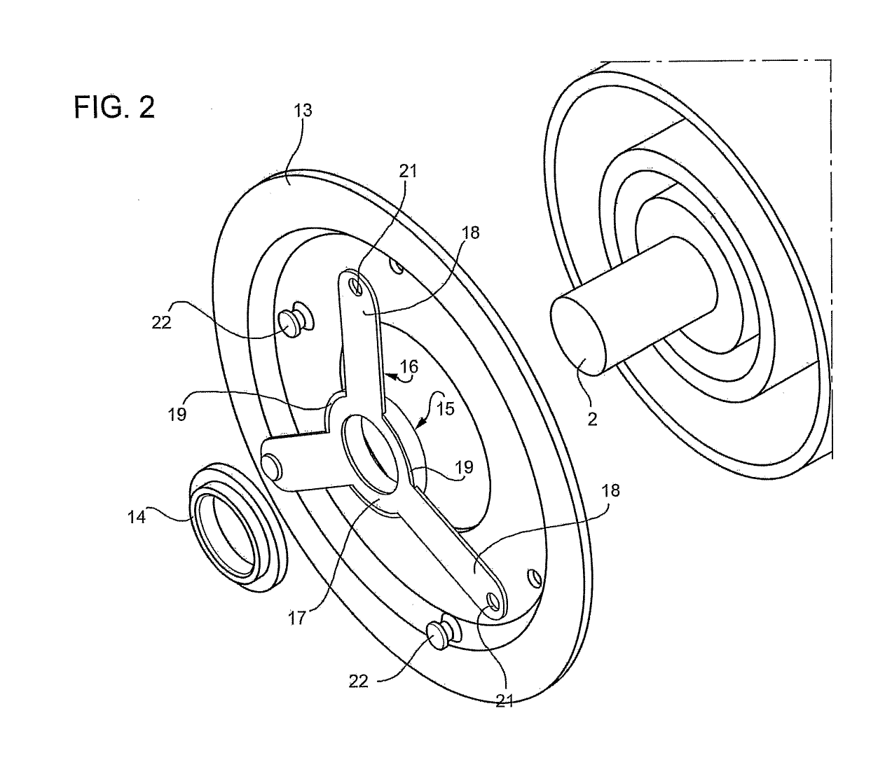

In particular, leaf spring 16 (FIG. 2) comprises a central portion 17 rigidly connected to locking assembly 14, 15 and a plurality of leaves 18, for instance two or more, radially extending from central portion 17 and having an elongated shape.

According to a preferred embodiment of the present invention, central portion 17 has a substantially cylindrical shape and is housed within a groove defined by ring 15. Ring 15 comprises a plurality of axial projections 19 that laterally surround central portion and define respective abutments that circumferentially come into contact with a respective leaf 18. In this manner, the rigid coupling between locking assembly 14, 15 and leaf spring 16 is obtained by means of a shape coupling.

In order to radially support armature 13, each leaf comprises a head portion 20 defining a hole 21 to house a corresponding rivet 22 so as to define a rigid connection between leaf spring 16 and armature 13.

Leaf spring 16 is obtained from a flat harmonic steel plate and subsequently has in its non-deformed configuration, a flat profile.

During mounting on shaft 2, leaf spring 16 is axially preloaded so as to ensure an axial force on armature 13 which, by applying a pressure on ring 11a, by friction ensures the rotational coupling between shaft 2 and pulley 3 when electromagnet 5 is not energised.

In particular, locking assembly 14, 15 defines the axial position of central portion 17 of leaf spring 16 and bearing 4 defines the axial position of ring 11a. When pulley assembly 1 is mounted on shaft 2, bearing 4 sandwiches locking assembly 14, 15 against a shoulder 23 of shaft 2. After the mounting on shaft 2, armature 13, pushed by ring 11a, is backed up towards electromagnet 5 and thereby preloads leaf spring 16 to ensure a friction torque suitable to drive the water pump when electromagnet 5 is not energised.

In the previously disclosed mounting configuration, a gap is defined between armature 13 and electromagnet 5, the gap being maximum when electromagnet 5 is not energised.

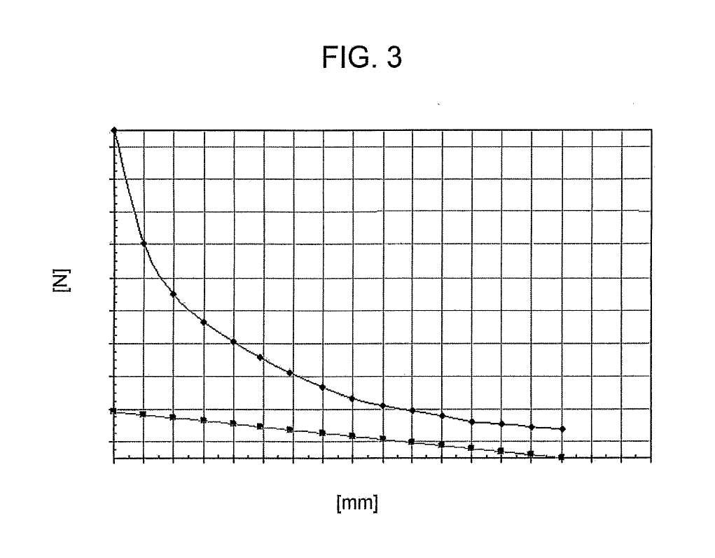

As is shown in FIG. 3, when electromagnet 5 is energised, the gap decreases and both the elastic reaction of leaf spring 16 and the attraction force of electromagnet 5 increase.

For the correct operation of friction coupling 7, it is required that the force of leaf spring 16 is always less with respect to the electromagnetic force. It is preferable that the electromagnetic force is at least 50% greater than the elastic force of leaf spring 16.

Thereby, when electromagnet 5 is energised, armature 13 separates from ring 11a and pulley 13 is idle with respect to shaft 2.

According to a preferred embodiment of the present invention, the employed materials may be selected to make the operation of the electromagnetic circuit more efficient.

In particular, pulley 3 is made of a non-magnetic material, for instance aluminium and the armature is made of a low residual induction material, for instance ductile iron. Thereby, the magnetic circuit closes on armature 13 and there are no dispersions which decrease the attractive force of the electromagnet so as to ensure a high number of coupling/decoupling cycles of pulley assembly 1.

Furthermore, ring 11a is made of a friction material having a friction coefficient in the range between 0.1 and 0.5 and a wear resistance in the range between 1*10̂-8 mm̂\hat{3}/Nm and 9*10̂-6 mm̂\hat{3}/Nm, preferably below 5*10̂-6 mm̂\hat{3}/Nm.

The advantages pulley assembly 1 allows to obtain are the following.

Pulley assembly 1 results both axially and radially compact and may be mounted on engines designed to initially provide a traditional pulley assembly.

Leaf spring 16 has a substantially non-deformed flat configuration and is therefore made by a simple and cost-effective process. In particular, after the spring is sheared from the harmonic steel strip, it is mounted on pulley assembly 1 without undergoing further permanent deformation processing.

Furthermore, leaf spring 16 has a substantially linear elastic feature which reliably ensures the driving of the water pump when electromagnet 5 is not energised even in the case of high wear of ring 11a. This guarantee allows to increase the working life of pulley assembly 1 and decrease the corresponding costs connected to the maintenance of a vehicle on which pulley assembly 1 is mounted.

Furthermore, leaf spring 16 simultaneously supports armature 13 avoiding sliding and guiding problems related to a grooved coupling. In particular, to allow a guiding suitable for the armature a considerable axial length needs to be provided for the portion of the armature that slides on the grooved hub.

It is finally apparent that modifications and variants can be made to pulley assembly 1 disclosed and illustrated herein without departing from the scope of protection of the present invention, as defined in the appended claims.

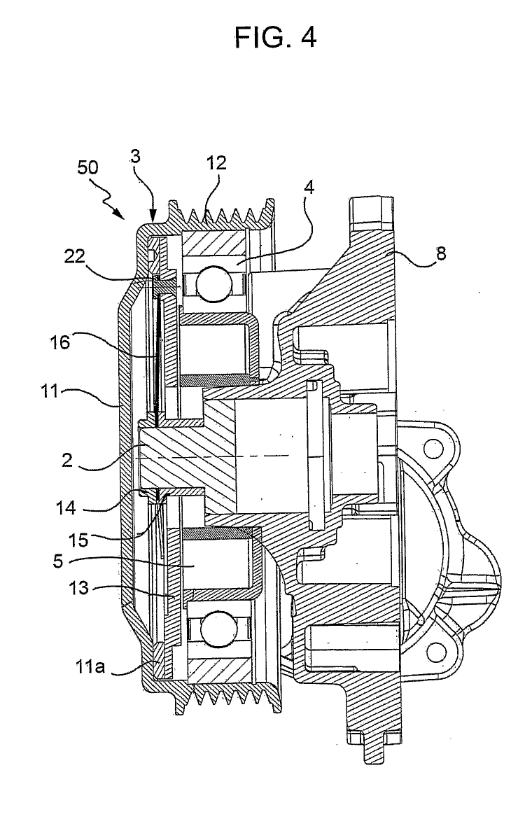

In particular, to further reduce the volume in an axial direction, the bearing may surround electromagnet 5 and be radially supported by the latter as shown in FIG. 4 for pulley assembly 50, in relation to which the same reference numerals already used in the previous description indicate functionally similar elements of pulley assembly 50 which form the already disclosed pulley assembly. In this configuration, the pulley does not comprise a hub and web 11 is continuous. Furthermore crown 12 is in contact with bearing 4, either directly of by means of a spacing ring, which has a medial plane passing through electromagnet 5.

Ring 11a may also be carried by armature 13.

1. A pulley assembly (1) having an axis (A) and comprising a locking assembly (14, 15) adapted to be connected to an input shaft (2) of a water pump, a pulley (3) adapted to be mounted idle with respect to said shaft (2), an armature (13) which is axially mobile in order to selectively cooperate by friction with said pulley (3), an electromagnet (5) for displacing said armature (13) arranged on an axially opposite side of said pulley (3) with respect to said armature (13), and an elastic element (16) which is preloaded in order to maintain in contact said armature (13) against said pulley (3) when said electromagnet (5) is not energised so that in the absence of electric current said pulley (3) is rotationally connected to said input shaft (2), wherein said elastic element (16) has a substantially flat shape in its non-loaded configuration.

2. The pulley assembly according to claim 1, wherein said elastic element (16) comprises a connection portion (17) rigidly fixed to locking assembly (14, 15) and a plurality of elongated leaves (18) extending from said connection portion (17) and fixed to said armature (13).

3. The pulley assembly according to claim 2, wherein said elastic element (16) radially supports said armature (13).

4. The pulley assembly according to claim 2, wherein a head portion (20) of each elongated leaf (18) faces said electromagnet (5).

5. The pulley assembly according to claim 1, wherein said elastic element (16) is rigidly connected to said locking element (14, 15) by a shape coupling.

6. The pulley assembly according to claim 1, wherein said pulley (3) is made of a non-magnetic material and by comprising a friction material ring (11a) axially interposed between said pulley (3) and said armature (13).

7. The pulley assembly according to claim 1, wherein said armature (13) is rigidly connected to said elastic element (16).

8. The pulley assembly according to claim 1, further including a bearing (4) which radially supports said pulley (3) and surrounds said electromagnet (5).

9. A water pump assembly comprising a pump having an input shaft (2) and a pulley assembly connected to said input shaft said pulley assembly having an axis (A) and comprising a locking assembly adapted to be connected to an input shaft of a water pump, a pulley adapted to be mounted idle with respect to said shaft, an armature which is axially mobile in order to selectively cooperate by friction with said pulley, an electromagnet for displacing said armature arranged on an axially opposite side of said pulley with respect to said armature, and an elastic means which is preloaded in order to maintain in contact said armature against said pulley when said electromagnet is not energised so that in the absence of electric current said pulley is rotationally connected to said input shaft, wherein said elastic element has a substantially flat shape in its non-loaded configuration.
